(19) United States
(12) Patent Application Publication
(10) Pub. No.: US 2006/0088741 A1
(43) Pub. Date: Apr. 27, 2006

(54) Methanol resistant cathodic catalyst for direct methanol fuel cells

(76) Inventors: Yushan Yan, Riverside, CA (US); Xin Wang, Singapore (SG)

Correspondence Address: FULWIDER PATTON, 6060 CENTER DRIVE, 10TH FLOOR, LOS ANGELES, CA, 90045, US

(21) Appl. No.: 11/262,027

(22) Filed: Oct. 27, 2005

Related U.S. Application Data
(60) Provisional application No. 60/622,732, filed on Oct. 27, 2004.

(51) Int. Cl. H01M 8/00; H01M 4/86; C08F 4/02; B01J 31/00; B01J 23/74

(52) U.S. Cl. 429/12; 429/40; 502/326; 502/117; 502/185

(57) ABSTRACT

Methanol-tolerant cathodic catalysts were prepared by depositing platinum nanoparticles and iron macrocycles on a carbon substrate. The order of depositing the iron and platinum on the carbon substrate were varied to form a (Fe—Pt)/C catalyst and a (Pt—Fe)/C catalyst. Different sintering temperatures were investigated to determine the heating effect on methanol tolerance. Oxygen reduction with and without the presence of methanol on these new catalysts was evaluated by using a rotating disk electrode system.

### CROSS-REFERENCES TO RELATED APPLICATIONS

This application claims the benefit of U.S. Provisional Application Ser. No. 60/622,732, filed Oct. 27, 2004, the content of which is hereby incorporated herein by reference.

This invention relates to an improved catalyst for use in direct methanol fuel cells, and more particularly a method of manufacturing such a catalyst using an iron macrocycle as an inhibitor for methanol oxidation.

### BACKGROUND OF THE INVENTION

A fuel cell is a device that converts the chemical energy of a fuel and an oxidant directly into electricity without combustion. The principal components of a fuel cell include electrodes catalytically activated for the fuel (anode) and the oxidant (cathode), and an electrolyte to conduct ions between the two electrodes, thereby producing electricity. The fuel typically is hydrogen or methanol, and the oxidant typically is oxygen or air (FIG. 11). Direct methanol fuel cells (DMFCs) have attracted enormous attention as a promising power source for portable electronics applications such as laptop computers and cell phones. The interest in commercializing DMFCs is in part due to the fuel cell's simple system design, high energy density and the relative ease with which methanol may be transported and stored, as compared with hydrogen.

In the state-of-the-art DMFCs, platinum supported on a carbon substrate is configured in the cathode as a catalyst for activating the oxygen reduction reaction (ORR). A platinum-ruthenium alloy is usually used as the anode electrocatalyst, and may be supported on a carbon substrate. The electrolyte is usually a perfluorosulfonate membrane, for which NAFION (available from DuPont) is a commonly utilized commercially available membrane.

One of the major problems encountered in DMFCs is methanol crossover from the anode to the cathode. The permeated methanol causes “poisoning” of the cathode platinum catalyst and depolarization losses due to the simultaneous oxygen reduction and methanol oxidation on the platinum catalyst. It has been proposed that one possible way to overcome the methanol crossover problem could be the use of a selective oxygen reduction catalyst that is inactive for methanol oxidation. Non-noble metal catalysts based on macrocycles of transition metals, chalcogenides or metal sulfide have been reported to have high methanol tolerance, and show the same ORR activity with or without the presence of methanol. Particularly, a carbon supported macrocycle derivatives of iron or cobalt have been shown to exhibit the most promising activity towards ORR. But overall, each of these methanol tolerance catalysts have ORR activity inferior to pure platinum catalysts.

In the base structure of an iron macrocycle, the central iron atom is coordinated with four nitrogen atoms (denoted as N₄—Fe). Upon heat treatment (less than or equal to 700° C.), the outer parts (surrounding organic groups) of the molecules are destroyed. However, the N₄—Fe coordination structure remains intact and may provide an active site for ORR. Another more stable catalytic site has been detected at pyrolysis temperatures of greater than 800° C. by the same authors. After heat treatment at temperatures above 800° C., the N4-Fe coordination structure decomposes into various elements. From the analysis of different ions by Time-of-Flight Secondary Ion Mass Spectrometry (TOF-SIMS), it has been reported that the relative intensity of the FeN₂C₄⁺ ion correlates well with the change of catalytic activity. This correlation suggests that the catalytic site is characterized by the FeN₂C₄⁺ signature, a structure for which one iron ion is complexed by two nitrogen atoms. Although showing high methanol tolerance, these materials did not attain the ORR activity of platinum in a methanol free electrolyte. Furthermore, the long time stability of these catalysts under fuel cell conditions has still to be improved. All these drawbacks make it unlikely that these catalysts will be used directly in practical fuel cell applications. Therefore, at the present time, a platinum based catalyst is still the choice for ORR in practical DMFCs.

Reference is made herein to the well-known rotating disk electrode, which is used in the testing of the present invention as described below. As will be appreciated by those of ordinary skill in the art, the rotating disk electrode (RDE) consists of a disk on the end of an insulated shaft that is rotated at a controlled angular velocity. Providing the flow is laminar over all of the disk, the mathematical description of the flow is surprisingly simple, with the solution velocity towards the disk being a function of the distance from the surface, but independent of the radial position. The rotating disk electrode is used for studying electrochemical kinetics under conditions, such as those of testing the present invention, when the electrochemical electron transfer process is a limiting step rather than the diffusion process.

Accordingly, there is a need for, and what was heretofore unavailable, a selective oxygen reduction catalyst that is inactive for methanol oxidation, has long time stability and attains the ORR activity of platinum in a methanol free electrolyte.

### SUMMARY OF THE INVENTION

The present invention is directed to a cathodic catalyst suitable for use in direct methanol fuel cells. The catalyst of the present invention includes iron (Fe) as an inhibitor for methanol oxidation. The catalyst is preferably composed of platinum (Pt) nanoparticles deposited on a carbon substrate containing heat-treated iron macrocycles—(Fe—Pt)/C. Alternatively, the cathodic catalyst may be composed of iron macrocycles deposited on a carbon substrate containing platinum—(Pt—Fe)/C. The catalyst of the present invention provides suppression of methanol oxidation while maintaining high activity towards oxygen reduction.

The present invention further includes methods of preparing cathodic catalysts containing platinum and iron that are suitable for use in direct methanol fuel cells. As an initial step in preparing a (Fe—Pt)/C catalyst of the present invention, a carbon-supported iron macrocycle is formed by mixing FeTPP chloride and carbon black in acetone. The mixture is filtered through a PTFE membrane. The PTFE membrane containing the iron/carbon/ethanol mixture is heated and maintained at a desired temperature before cooling the membrane to produce an iron-on-carbon substrate (Fe/C). A modified alcohol reduction method may be used to deposit platinum nanoparticles on the formed Fe/C substrate. Thereafter, the platinum containing Fe/C catalyst is further heat-treated to sinter the platinum and iron particles to form the (Fe—Pt)/C catalyst of the present invention.

A further aspect of the present invention is a method of preparing a (Pt—Fe)/C catalyst. To prepare this alternative cathodic catalyst, platinum nanoparticles are mixed with carbon black and filtered onto a PTFE membrane (Pt/C). To complete the (Pt—Fe)/C catalyst, iron macrocycles are deposited on the Pt/C substrate, which is then sintered.

The (Fe—Pt)/C catalyst and (Pt—Fe)/C catalyst of the present invention were tested using standard rotating disk electrode (RDE) techniques. The catalysts were ultrasonically dispersed in ethanol to form an ink. The ink was applied to a polished glassy carbon disk having an alumina suspension. An aliquot of diluted NAFION solution was pipetted onto the electrode surface to attach the catalyst particles onto the glassy carbon substrate.

The cathodic catalyst of the present invention solves a common problem in DMFCs known as “methanol poisoning,” which is caused by methanol crossover from the anode to the cathode. The crossover causes depolarization losses at the cathode due to simultaneous oxygen reduction and methanol oxidation at the platinum catalyst. The use of iron in the cathodic catalyst reduces the potential for methanol oxidation at the cathode, since iron is more methanol tolerant than platinum. However, the iron provides some potential for oxygen reduction, albeit less than that for platinum. The present invention further incorporates iron macrocycles in the cathodic catalyst, since such macrocycles have relatively high oxidation reduction reaction activity with or without the presence of methanol. The present invention is the first to combine an iron macrocycle with platinum on a carbon substrate to inhibit the effects of methanol poisoning on a cathodic catalyst.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 shows X-Ray diffraction patterns of three (Fe—Pt)/C catalysts of the present invention.

FIG. 2(a) depicts a transmission electron micrograph of an as-synthesized (Fe—Pt)/C catalyst of the present invention.

FIG. 2(b) depicts a transmission electron micrograph of a 500° C. heat treated (Fe—Pt)/C catalyst of the present invention.

FIG. 2(c) depicts a transmission electron micrograph of a 700° C. heat treated (Fe—Pt)/C catalyst of the present invention.

FIG. 3 is a family of curves representing potentiodynamic currents for ORR on Pt/C at different rotation rates.

FIG. 4 is a family of curves representing potentiodynamic currents for ORR on Fe/C at different rotation rates.

FIG. 5 is a family of curves representing potentiodynamic currents for ORR on (Fe—Pt)/C sintered at different temperatures with and without the presence of methanol.

FIG. 6 is a family of curves representing the comparison of weight normalized potentiodynamic currents for ORR.

FIG. 7 is a family of curves representing determination of the reaction order with respect to O₂ for ORR on (Fe—Pt)/C sintered at 700° C.

FIG. 8 is a family of curves representing Levich-Koutecky plots for ORR on (Fe—Pt)/C sintered at 700° C.

FIG. 9 is a family of curves representing mass transport corrected Tafel plots for ORR on (Fe—Pt)/C sintered at 700° C.

FIG. 10 is a family of curves representing comparison of cell polarization curves for Pt/C and (Fe—Pt)/C cathodes.

FIG. 11 is a schematic of a direct methanol fuel cell in accordance with the present invention.

### DETAILED DESCRIPTION OF THE PREFERRED EMBODIMENTS

As shown in the drawings for purposes of illustration, the present invention is directed to a cathodic catalyst for direct methanol fuel cells (DMFC) that uses an iron macrocycle as an inhibitor for methanol oxidation. The present invention includes a method of preparing iron and platinum catalysts by sintering iron macrocycles and platinum nanoparticles on a carbon substrate. The catalyst of the present invention provides suppression of methanol oxidation while maintaining high activity towards oxygen reduction for incorporation into a DMFC cathode. The iron and platinum catalysts were tested using standard techniques with a rotating disk electrode (RDE).

In view of the problems and deficiencies encountered with prior art DMFC catalysts, it is desirable to achieve a methanol-tolerant catalyst with high activity towards an oxygen reduction reaction (ORR). In one embodiment of the present invention, the cathodic catalyst combines the high ORR activity potential of platinum (Pt) and the high methanol tolerance of metal macrocycles. The concept that was tested, and proven to be effective as set forth herein, is firstly that, by high temperature sintering of platinum particles deposited in the vicinity of iron (Fe) active sites (for example, derived from heat treated iron macrocycles), a good mixing of platinum and iron on the molecular level can be realized. Secondly, since the dissociative chemisorption of methanol requires the existence of several adjacent platinum ensembles, it is believed that the presence of methanol-tolerant iron active sites around the platinum active sites blocks methanol adsorption on the platinum sites due to a dilution effect. Consequently, methanol oxidation on the binary-component catalyst (that is, platinum and iron) is suppressed. Oxygen adsorption, which requires only two adjacent sites and can be regarded as dissociative chemisorption in the relevant temperature range, occurs on both the iron and the platinum sites. As both iron and platinum sites are active towards oxygen reduction, the overall oxygen reduction rate on the binary metal surface remains very high.

In accordance with methods of production of the present invention, Pt—Fe catalysts may be prepared under different conditions. As an initial matter of verification, the activities of catalysts of the present invention towards ORR, with and without the presence of methanol, were evaluated in standard electrolytes under controlled mass transport using the well-known rotating disk electrode system. The results are described below. The same catalyst was then tested in a simplified fuel cell membrane electrode assembly (MEA). These results are also described below. Both forms of testing confirm the improved efficacy of the resulting Pt—Fe catalyst of the present invention for use in a DMFC.

In accordance with the present invention, a carbon supported iron macrocycle was prepared at room temperature by:

(1) dissolving fifty milligrams (mg) of 5,10,15,20-tetraphenyl-21H,23H porphine iron(III) (FeTPP) chloride (Aldrich Chemical) in ten milliliters (ml) of acetone;

(2) ultrasonically dispersing fifty mg of carbon black (Vulcan XC-72, Cabot Corporation) in another ten ml of acetone and then adding the dispersion to the FeTTP chloride-acetone solution;

(3) agitating the FeTPP chloride-acetone-carbon black mixture using a magnetic stirrer for about twenty-four hours; and

(4) rapidly filtering the FeTPP chloride-acetone-carbon black mixture through a 0.2 micrometer (μm) pore size polytetrafluoroethylene (PTFE) membrane (Advantec MFS Inc. of Dublin, Calif., USA) to form the iron macrocycle preparation.

As will be appreciated by those of ordinary skill in the art, various forms of iron precursors, such as tetra-aza-annulenes, phthalocyanines and other N₄—Fe chelate may be used to prepare the iron macrocycle for use in the catalyst of the present invention. Similarly, macrocycles of other metals, such as cobalt, may be used to form a binary-component catalyst. However, it is expected that cathodic catalyst having such metals will have an ORR potential inferior to those cathodic catalysts formed with iron.

In accordance with the present invention, a fused silica boat containing the iron macrocycle preparation was then introduced into a quartz tube, which was positioned within a tubular furnace. Argon gas was then introduced through the quartz tube at one-hundred and fifty standard cubic centimeters per minute (sccm) for thirty minutes. The furnace was then heated to 800° C. at a ramp rate of 40° C. per minute and maintained at that temperature for two hours before cooling the iron macrocycles to about room temperature. A thermo-gravimetric analysis determined the iron loading on the carbon support to be 4.5 percent by weight. The prepared carbon supported iron macrocycle is denoted herein as Fe/C.

The following procedure was adopted to add platinum to the carbon supported iron macrocycle. The deposition of platinum nanoparticles on the formed Fe/C was realized by a modified alcohol reduction method:

(1) A suspension was formed from 4.2 ml of aqueous 24.4 millimolar (mM) H₂PtCl₆ (Aldrich Chemical), 0.6 grams (g) dodecyldimethyl (3-sulfo-propyl) ammonium hydroxide (Aldrich Chemical) and eighty mg of Fe/C being added into one-hundred-twenty ml of a methanol and water mixture, having a methanol/water volumetric ratio of 1:3. Carbon black may be substituted for Fe/C for preparation of carbon-supported platinum (Pt/C).

(2) The resulting suspension was stirred and refluxed under air at 85° C. for one hour. The suspension was then filtered and washed thoroughly with ethanol and water. An analysis on the filtrate with inductively coupled plasma atomic emission spectroscopy determined that most of the platinum has been adsorbed on the support with nominal loading of about twenty weight percent.

(3) The platinum and iron on carbon catalyst was heat-treated at 700° C. under argon atmosphere for about one hour. This heat-treatment apparently sintered the iron and platinum on the carbon substrate. This prepared catalyst is denoted herein as (Fe—Pt)/C. This (Fe—Pt)/C catalyst was found to have a Pt:Fe atomic ratio of 1.6:1.

To investigate the deposition order effect, another catalyst was prepared by first forming platinum nanoparticles on carbon black, then adsorbing iron macrocycles on the Pt/C substrate and sintering at 700° C. under argon atmosphere for one hour (denoted as (Pt—Fe)/C). The quantities of the chemicals remained the same as those described heretofore for (Fe—Pt)/C preparation. Physicochemical characterization of the prepared catalysts was conducted by X-ray diffraction using a Siemens D-500 diffractometer with CuK_{α} radiation, and by transmission electron microscopy (TEM) using a Philips CM300 instrument.

A working electrode (RDE) was prepared for assessment by applying an “ink” containing the (Fe—Pt)/C catalyst to a glassy carbon disk (Pine Instrument, 5 mm diameter). Before each experiment, the glassy carbon disk of the RDE was polished to a mirror finish with 0.05 μm alumina suspension.

(1) Four milligrams of the prepared (Fe—Pt)/C catalyst was ultrasonically dispersed in one milliliter of ethanol for thirty minutes to form an ink.

(2) An aliquot of ten microliters (μl) of (Fe—Pt)/C catalyst ink was then pipetted onto the disk so as to provide a platinum loading of forty micrograms per square centimeter (μg/cm²). However, for testing the Fe/C catalyst, thirty-five mg of catalyst was dispersed in one ml ethanol to give an iron loading of eighty μg/cm².

(3) The (Fe—Pt)/C catalyst ink was dried onto the RDE at 80° C. for about five (5) minutes.

(4) Ten ml of a 0.05 weight-percent NAFION solution was prepared by diluting a five weight-percent NAFION solution (available from Ion Power, Inc.) with DI water.

(5) The 0.05 weight-percent NAFION solution was pipetted onto the electrode surface in order to attach the (Fe—Pt)/C catalyst particles onto the glassy carbon substrate of the RDE. By assuming NAFION density of 1.98 grams per cubic centimeter (g/cm³), the film thickness was calculated to be 0.13 μm. The influence of NAFION film diffusion resistance on the measured current has been reported to be negligible for a film thickness lower than 0.2 μm.

The catalyst prepared according to the above-recited method of the present invention was tested in the well-known rotating disk electrode system. Each electrochemical measurement was conducted in a thermostatically controlled (25° C.) three-compartment glass cell using a Solartron electrochemical interface (model number SI1287). Electrode potentials were measured and reported against a silver/silver-chloride (Ag/AgCl) electrode placed close to (proximate to) the (Fe—Pt)/C working electrode through a Luggin capillary. A platinum wire was used as counter-electrode.

After preparation, the (Fe—Pt)/C working electrode was immersed in deaerated [nitrogen gas (N₂) purged] 0.5 molar (M) sulfuric acid (H₂SO₄) under potential control at 0.1 volts (V). The electrode potential was cycled ten times between −0.1 V and 1.0 V in order to produce a clean electrode surface. The electrolyte was then saturated with oxygen gas (O₂) in order to conduct oxygen reduction experiments. Potentiodynamic measurement was conducted at a scan rate of twenty millivolts per second (mV/s) with or without the presence of one molar methanol (CH₃OH) in the electrolyte at different rotation rates. The results of these experiments are reported below.

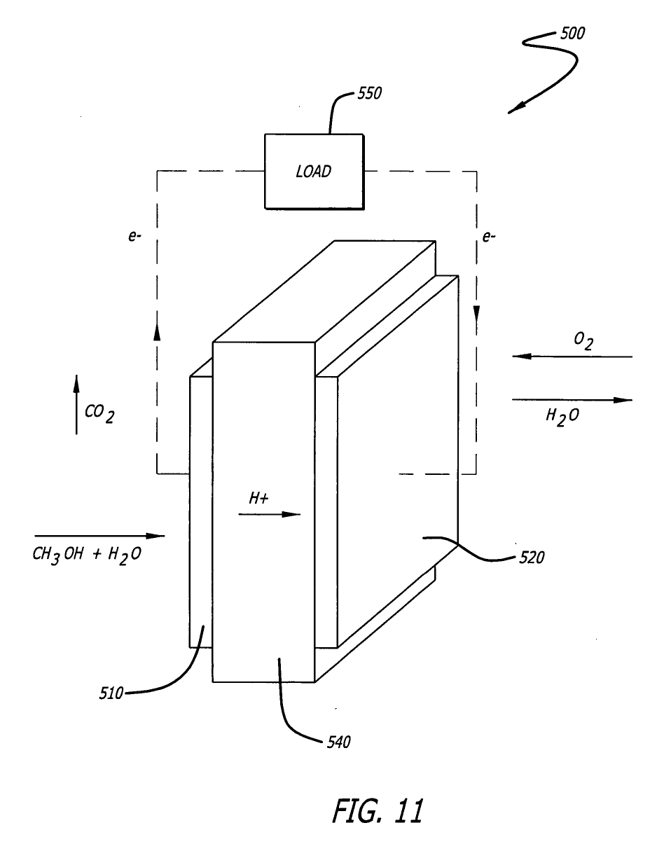

The catalyst prepared according to the above-recited method of the present invention was also tested in a membrane electrode assembly (MEA). As shown in FIG. 11, the MEA used for testing the prepared catalyst was prepared by using a membrane formed from NAFION 115 (DuPont), an anode formed from twenty weight percent Pt/C (E-TEK) having platinum loading of about 0.3 mg/cm, and a cathode formed from (Fe—Pt)/C catalyst having platinum loading of about 0.4 mg/cm prepared according to the above-recited method of the present invention. The electrodes were prepared by brushing catalyst ink (prepared as described above) onto carbon paper formed with a preformed gas diffusion layer having carbon loading of about 4.0 mg/cm. For comparative purposes, another MEA with the same platinum loading was made, except that twenty weight percent Pt/C (E-TEK) was used in preparing the cathode.

Polarization curve measurement was then conducted in a five cm² single fuel cell test station (Electrochem, Inc., USA) at a cell temperature of about 50° C. while at atmospheric pressure. To minimize the experimental uncertainties in the anode side due to the slow methanol oxidation, hydrogen was used at the anode and the mixture of oxygen and methanol was fed to the cathode. Before entering the cell, the hydrogen was humidified at 60° C. At the cathode side, to introduce the methanol into the oxygen stream, pure oxygen gas was bubbled through a ten weight percent methanol aqueous solution thermostatically held at 50° C. The vapor pressure of methanol in the gas stream was estimated to be about 0.03 atmospheres. The flow rates of hydrogen and oxygen were fixed at two-hundred and one-hundred standard sccm, respectively.

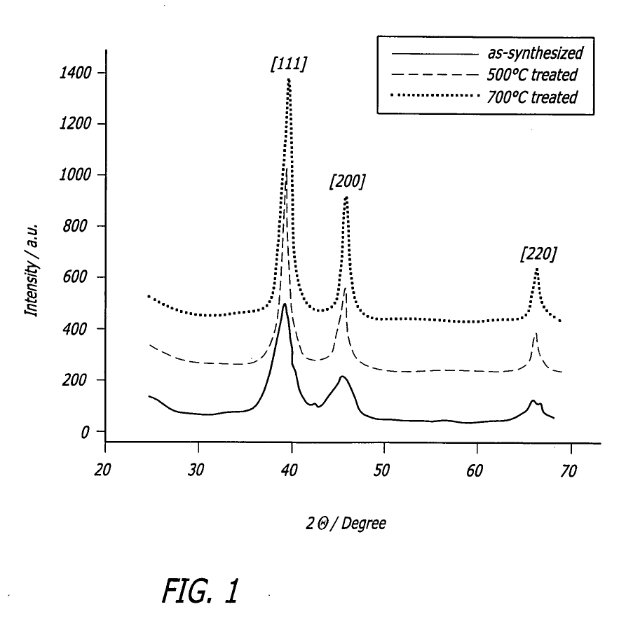

Referring now to FIG. 1, X-Ray diffraction patterns were obtained using (Fe—Pt)/C catalysts prepared according to the above-recited method of the present invention, wherein the catalyst were sintered at different temperatures. From the diffraction angle of the highest (platinum) peak [111] (the Miller index) found in each pattern, the lattice parameter of the three (Fe—Pt)/C catalysts was calculated at 3.920 angstroms (Å) for the non-sintered (as-synthesized) catalyst, 3.915 Å for the 500° C. sintered catalyst, and 3.905 Å for the 700° C. sintered catalyst. Since the lattice parameter for the non-sintered (as-synthesized) catalyst is very similar to the lattice parameter for pure platinum metal, the as-synthesized catalyst is apparently a bimetallic mixture. As the sintering temperature is increased, the lattice parameter is found to decrease, indicating the gradual formation of a Pt—Fe alloy.

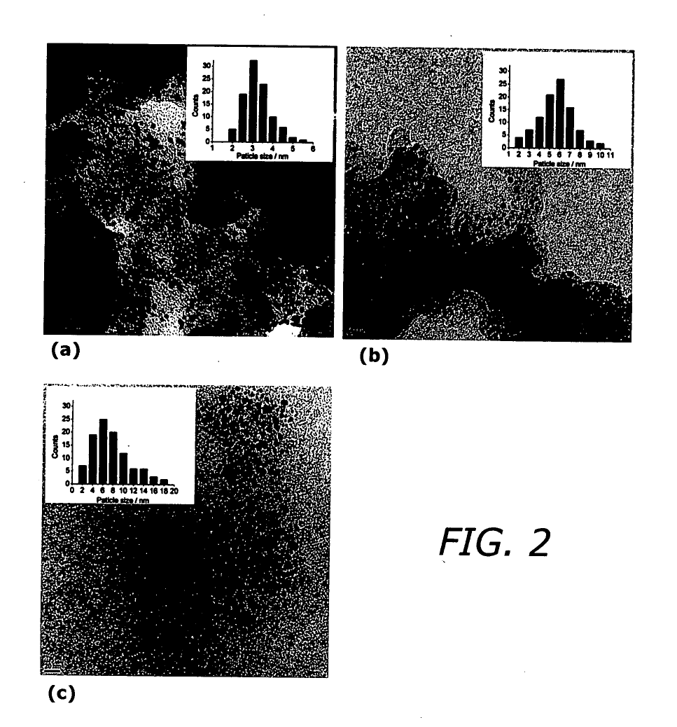

The face-centered-cubic (“FCC”) structures of platinum can be identified on the X-Ray diffraction graphs shown in FIG. 1. No diffraction peak corresponding to iron was observed, however, indicating that iron might exist as amorphous phase or may have formed an alloy with the platinum. Since it is difficult to obtain a quantitative alloy composition due to the unknown theoretical correlation between the lattice parameter and Pt—Fe alloy composition, the possibility of the existence of non-alloy bimetallic mixture cannot be ruled out. The diffraction peaks become sharper with the increase of sintering temperature, suggesting an increase of the crystal size. From the line broadening of the platinum peak [111], the average particle size was calculated to be 3.4 nanometers (nm) for the as-synthesized catalyst, 7.1 nm for the 500° C. treated catalyst, and 9.2 nm for the 700° C. treated catalyst. As shown in FIGS. 2(a), 2(b) and 2(c), the increase in particle size can also be observed in transmission electron microscope (TEM) images, which show the morphology and size of the catalyst particles. A broadening of particle size distribution with the increase of treatment temperature can be seen from the histograms, see insets of FIGS. 2(a), 2(b) and 2(c). Since nanoparticles are thermodynamically unstable, they tend to migrate and form large particles to decrease the surface energy. The higher the temperature, the easier the nanoparticles can migrate, resulting in larger particle size.

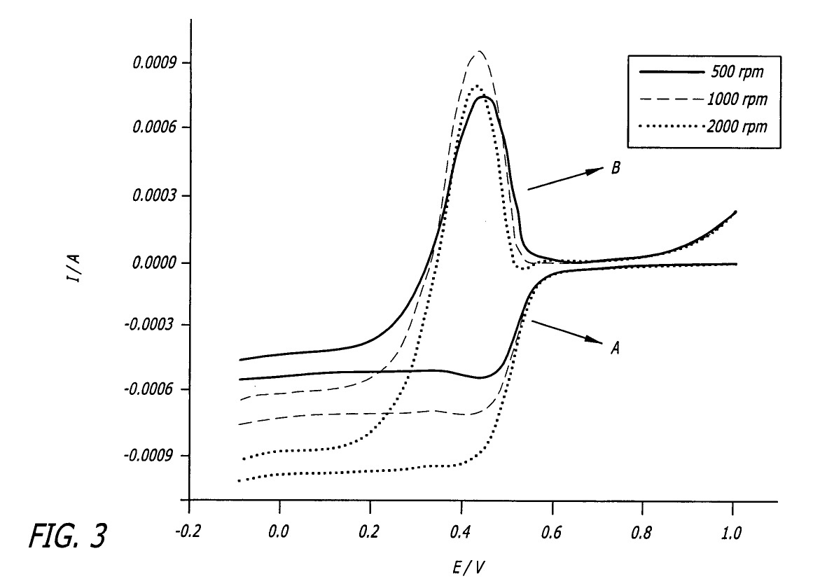

Referring to FIG. 3, the potentiodynamic currents for the oxidation reduction reaction (ORR) for platinum on a carbon substrate (Pt/C) were measured using a rotating disk electrode system at rotation rates of five-hundred, one-thousand and two-thousand revolutions per minute (rpm) with a scan rate of twenty millivolts per second (mV/s). When oxygen saturated sulfuric acid (0.5 M H₂SO₄) was used as the electrolyte, the methanol free curves (A) demonstrate a typical cathodic current plateau due to oxygen mass transport limitation is observed for the ORR with the decrease of potential. When methanol was added (1.0 M CH₃OH) to the oxygen saturated sulfuric acid (0.5 M H₂SO₄) electrolyte, the methanol curves (B) demonstrated an anodic peak at the potential range of 0.2-0.6 V, suggesting that platinum is also active towards methanol oxidation. The anodic current was found to be independent of the rotation rate. This finding indicates that the methanol oxidation on Pt/C is kinetically controlled.

By comparing the methanol-free curves (A) with the methanol curves (B) in FIG. 3, it was found that the existence of methanol interferes with the ORR starting from about 0.6 V. Interestingly, at potential lower than 0.2 V where it is known that no methanol oxidation occurs on platinum, the limiting ORR current is still smaller with the presence of methanol. This is apparently due to the blocking of catalytic sites by strong adsorption of the residues (mostly carbon monoxide) from methanol dissociation. For methanol oxidation on a platinum catalyst in an oxygen-free electrolyte, it is known that the surface coverage of residue will approach unity at potential lower than 0.2 V. If coverage of residue is still retained with the presence of oxygen in the electrolyte, no visible ORR current should be seen as no active sites available for ORR. In reality, ORR current is still observed; suggesting certain amounts of the platinum sites are not occupied by residue or we say the catalyst is less poisoned. Possible explanations for the less poisoning are the competitive adsorption for platinum sites by the oxygen and the surface reaction between the adsorbed residue species and oxygen-containing surface intermediate.

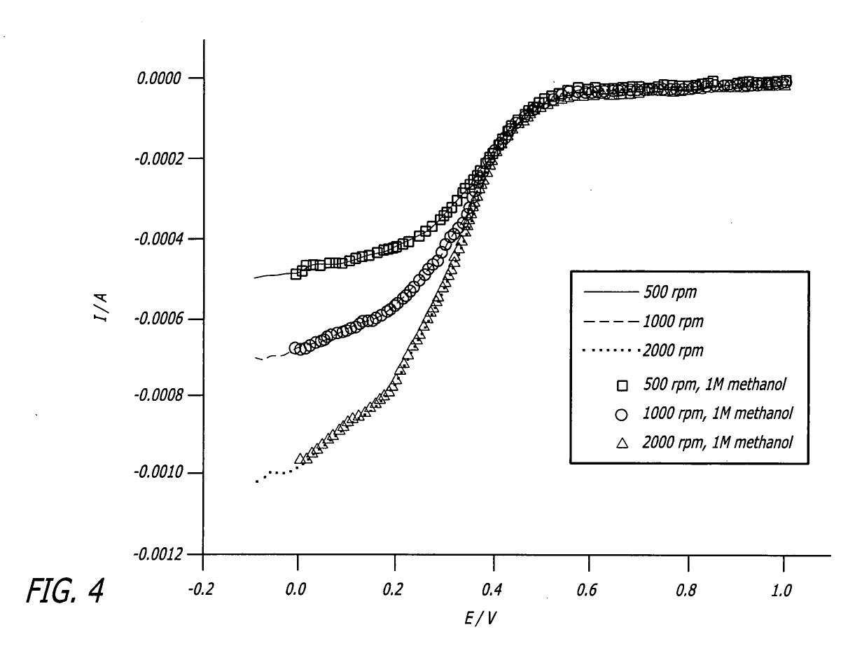

Referring to FIG. 4, the potentiodynamic currents for the oxidation reduction reaction (ORR) for iron on a carbon substrate (Fe/C) were measured using a rotating disk electrode system at rotation rates of five-hundred, one-thousand and two-thousand rpm with a scan rate of twenty mV/s. Again, oxygen saturated sulfuric acid with and without methanol was used at each rotation rate. The results of those experiments indicate that the ORR rate on Fe/C is not influenced by the presence of methanol. It is evident from those experiments that Fe/C is totally inactive towards methanol oxidation. Further, no well-expressed limiting current plateau was observed at any of the experiments' rotation rates. This phenomenon has been reported previously with regard to Fe/C, and is attributed to the insufficient catalytic activity of the investigated Fe/C catalyst. The insufficient catalytic activity of Fe/C can also be demonstrated by the cathodic shift of the potential required for the onset of oxygen reduction as compared with Pt/C. Such low activity makes Fe/C catalysts unsuitable to be directly used in DMFC.

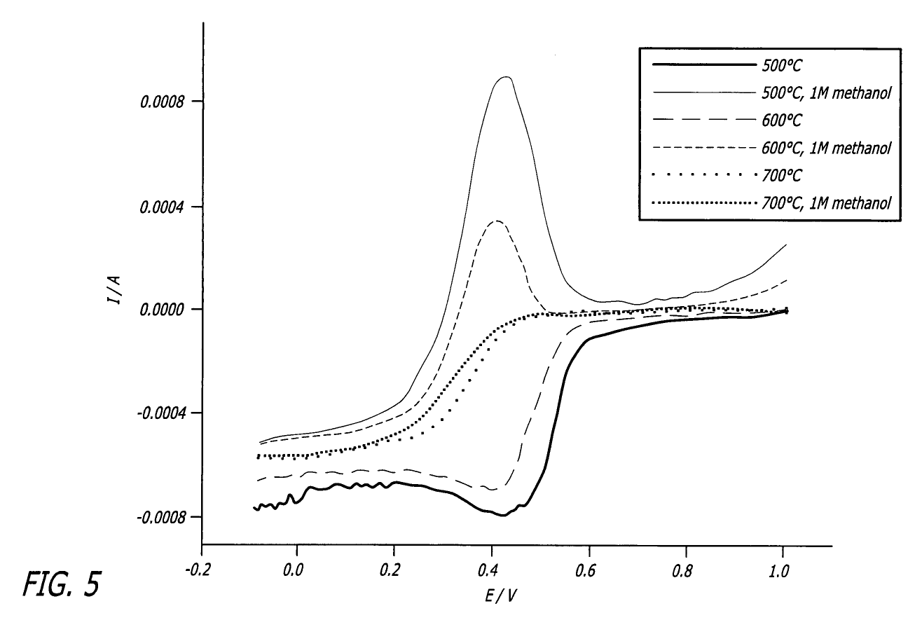

Referring to FIG. 5, the potentiodynamic currents for the oxidation reduction reaction (ORR) for platinum and iron on a carbon substrate (Fe—Pt)/C were measured using a rotating disk electrode system at a rotation rate one-thousand rpm with a scan rate of twenty mV/s. To combine the benefits of the methanol tolerance of Fe/C and the high activity of platinum, catalysts were prepared by sequential deposition of the two metals on a carbon support structure and sintered at different temperatures. To evaluate the sintering temperature effect, the potentiodynamic current for ORR on (Fe—Pt)/C heat treated at 500° C., 600° C. and 700° C. were measured using oxygen saturated sulfuric acid with and without methanol. For increasing sintering temperatures, the limiting current for ORR in the absence of methanol was found to decrease, apparently because of catalyst particle ripening at higher temperature. However, when methanol is added, the limiting ORR current is progressively higher and the methanol oxidation is progressively weaker with increasing temperature treatments.

For the catalyst that was heat treated at 700° C., the methanol oxidation was almost completely suppressed, suggesting that a better alloying of the iron and platinum is beneficial for the oxidation reduction reaction. It is believed that the processes of methanol adsorption and oxygen adsorption are competing with each other for the iron and platinum surface sites of the catalyst. For the catalyst sintered at 700° C., the better mixing of the iron and platinum makes methanol adsorption less favored as iron sites are inactive for methanol adsorption. Consequently, the methanol oxidation current is negligible compared with the oxygen reduction current. Apparently due to the presence of oxygen, no methanol oxidation current on (Fe—Pt)/C sintered at 700° C. was observed (see FIG. 5 ). However, the cyclic voltammogram for (Fe—Pt)/C in 0.5 M H₂SO₄+1.0 M CH₃OH purged with nitrogen gas demonstrated a methanol oxidation current that was three times lower than demonstrated when Pt/C was used. This observation reinforces the belief that the presence of oxygen is interfering with the methanol adsorption and oxidation.

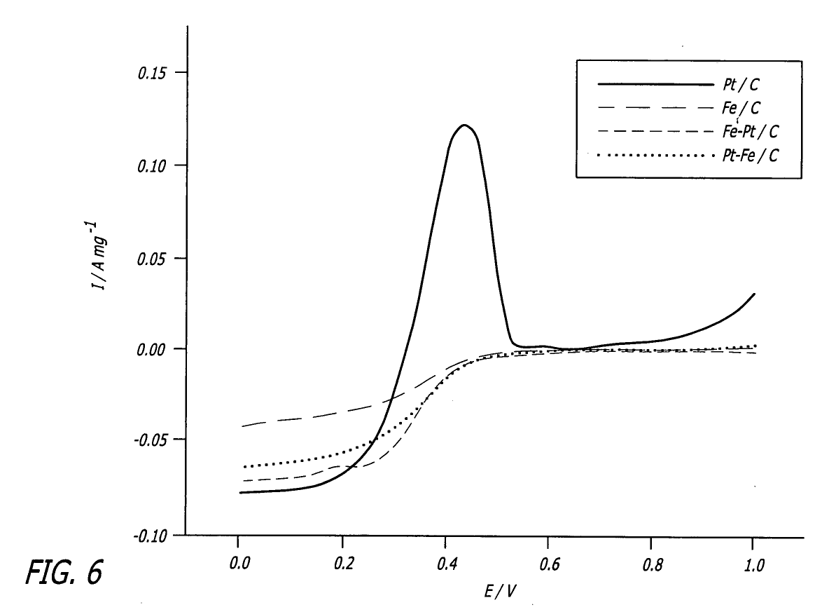

The order of deposition platinum and iron on the carbon support structure was evaluated in terms of the oxidation reduction reaction. Referring to FIG. 6, the potentiodynamic currents for the oxidation reduction reaction for Pt/C, Fe/C, (Fe—Pt)/C, (Pt—Fe)/C were measured using a rotating disk electrode system at a rotation rate one-thousand rpm with a scan rate of twenty mV/s. The ORR activity was measured using methanol (1.0 M CH₃OH) in oxygen saturated sulfuric acid (0.5 M H₂SO₄). The experiments demonstrated that (Pt—Fe)/C sintered at 700° C. gives slightly poorer oxidation reduction reaction activity than (Fe—Pt)/C sintered at 700° C. One possible reason for the difference is that the later formed iron active sites in (Pt—Fe)/C cover some of the platinum sites, physically blocking them from oxygen molecules. Further evidence for this hypothesis was provided by the decrease in hydrogen desorption-adsorption peak current from the cyclic voltammogram in the nitrogen gas purged blank electrolyte (without the presence of methanol).

Considering that platinum is expensive and has much higher inherent activity than iron, the results for the order of deposition experiment (see FIG. 6) are presented based on the same platinum loading for the three platinum based catalysts. For Fe/C, the measured activity was normalized based on iron loading. The lower inherent activity for iron than for platinum can also be clearly identified from the experimental results (see FIG. 6). Furthermore, it was observed that the normalized oxidation reduction reaction activity at the kinetics-controlled region (0.3-0.4V on FIG. 6) decreases in the order of (Fe—Pt)/C greater than (Pt—Fe)/C, which was greater than Pt/C, which was greater than Fe/C. However, the limiting current at the diffusion controlled region of (Pt—Fe)/C and (Fe—Pt)/C (0.0-0.2V on FIG. 6) is lower than that of Pt/C, which can be explained by the smaller particle size of the Pt/C compared with the particle size of the high temperature sintered binary-metal catalysts. Since (Fe—Pt)/C sintered at 700° C. demonstrated the best performance at the kinetics-controlled region, it was the focus of further investigation on the ORR kinetics.

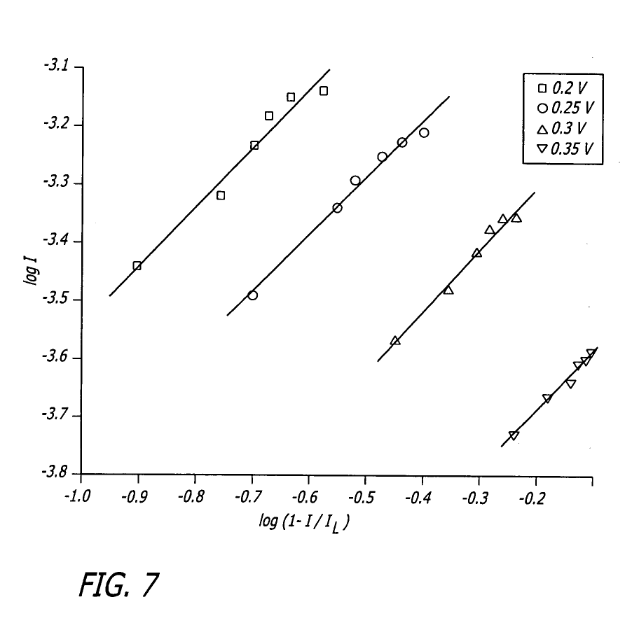

The potentiodynamic currents of the oxidation reduction reaction on Fe—Pt/C sintered at 700° C. were measured at different rotation rates using the rotating disk electrode system, wherein the oxidation reduction reaction was under mixed kinetic-diffusion control. The reaction order with respect to oxygen was then determined using the relationship (Equation 1) between measured and limiting current at different rotation rates, where “I” is the measured current, “Iₖ” is the kinetic current in the absence of any mass-transfer effect, “p” is the reaction order and “I_{L}” is the limiting current that is obtained by averaging the measured currents in the potential range of 0.0 to 0.3 volts (V). As shown in (FIG. 7), straight lines with unity slope (1.00±0.08) were obtained when the logarithm of the measured current “log I” was plotted against the logarithm of one minus the measured current divided by the limiting current “log (1−I/I_{L})” at different potentials (0.2, 0.25, 0.3 and 0.35 volts). This data indicates that the oxidation reduction reaction on the (Fe—Pt)/C catalyst obeys first-order kinetics in the studied potential range.

$$log I = log {I}_{k} + p log ( 1 - \frac{I}{{I}_{L}} ) \qquad ( 1 )$$

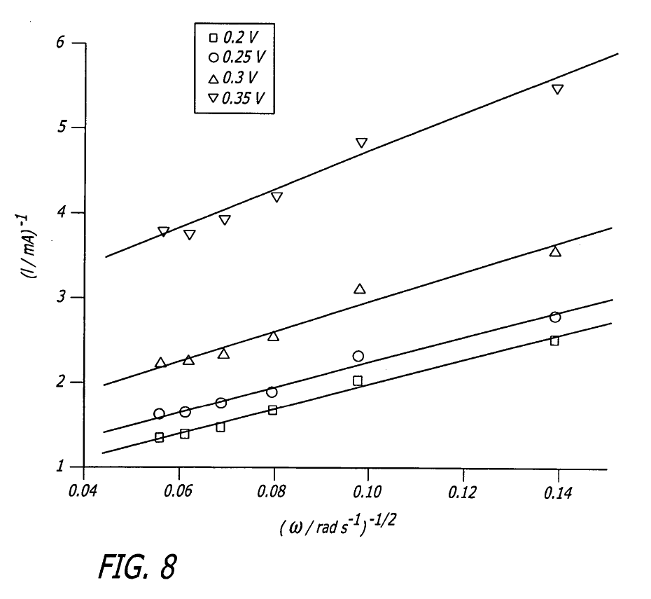

As shown in (FIG. 8), Levich-Koutecky plots for the first order reaction were obtained by plotting the inverse of the measured current against the inverse of the square root of the rotation rate of the rotating disk electrode. Parallel lines at different potentials were observed in the plots, further confirming that the oxidation reduction reaction on (Fe—Pt)/C is a first-order reaction. For the rotating disk electrode setup used in the experiments, the measured current can be expressed in Equation 2, where “I” is the measured current, “I_{f}” is the diffusion limiting current in the NAFION film covering the catalyst layer, “C_{f}D_{f}” is the oxygen solubility-diffusivity product in the film, “I_{Lev}” is the diffusion limiting current through the solution boundary layer (the so-called “Levich current”), “n” is the transferred electron number per oxygen molecule, “F” is the Faraday constant, “S” is the electrode surface area, “D₀” is the diffusion coefficient of oxygen in the solution, “υ” is the kinematic viscosity of the solution (electrolyte where experiments were conducted, in this case, is 0.5 M H₂SO₄ solution with or without 1 M CH₃OH), “C₀” is the bulk concentration of oxygen in the solution, and “ω” is the rotation rate of the rotating disk electrode. Because other parameters in the slope expression are fixed except n, the similarity in the slopes in the plotted curves implies that the transferred electron number per oxygen molecule is similar within the investigated potential range. It is known that the oxidation reduction reaction is complicated and can proceed via different pathways on different catalysts or under different conditions, for example, a four-electron route or a two-electron route. The resulting electron number may vary depending on the dominant mechanism. Therefore, the similar electron number obtained in this experiment indicates that there is no mechanism change for the oxidation reduction reaction on the (Fe—Pt)/C catalyst within the investigated potential range (the oxygen reduction on Fe—Pt/C follows same route as that on Pt/C):

$$\frac{1}{I} = \frac{1}{{I}_{k}} + \frac{1}{{I}_{f}} + \frac{1}{{I}_{Lev}} = \frac{1}{{I}_{k}} + \frac{L}{{nFC}_{f} {D}_{f}} + \frac{1}{0.62 {nFSD}_{0}^{2 / 3} {υ}^{- 1 / 6} {C}_{0} {ω}^{1 / 2}} \qquad ( 2 )$$

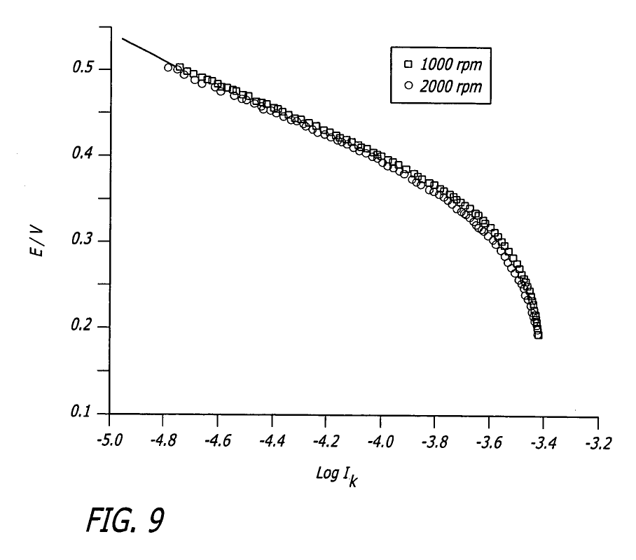

As shown in FIG. 9, Tafel plots were obtained using data based on the observed first-order reaction. Kinetic currents at different rotation rates were extracted from the measured potentiodynamic current after correction for diffusion effects using Equation 3. It was observed that the curves for different rotating rates overlap with each other. The Tafel slope is about one-hundred and thirty millivolts per decade at potential range of 0.3 to 0.5 volts, which agrees with the theoretical value for one electron transfer determined by Equation 5. A similar value for the oxidation reduction reaction on a platinum catalyst has been reported in the literature, for which the transfer of the first electron (see Equation 4) is usually regarded as the rate determining step. Since there was a similar Tafel slope and reaction order obtained in the present experiment as compared with the reported literature, it may be reasonably anticipated the same mechanism will also be valid for the Fe—Pt/C catalyst that is the subject of the present invention.

$$\begin{matrix}{I}_{k} = \frac{{I}_{L} I}{{I}_{L} - I} & ( 3 ) \\ Pt - {O}_{2} + {H}^{+} + {e}^{-} \to Pt - {O}_{2} H & ( 4 ) \\ b = \frac{2.3 \times RT}{α nF} & ( 5 )\end{matrix}$$

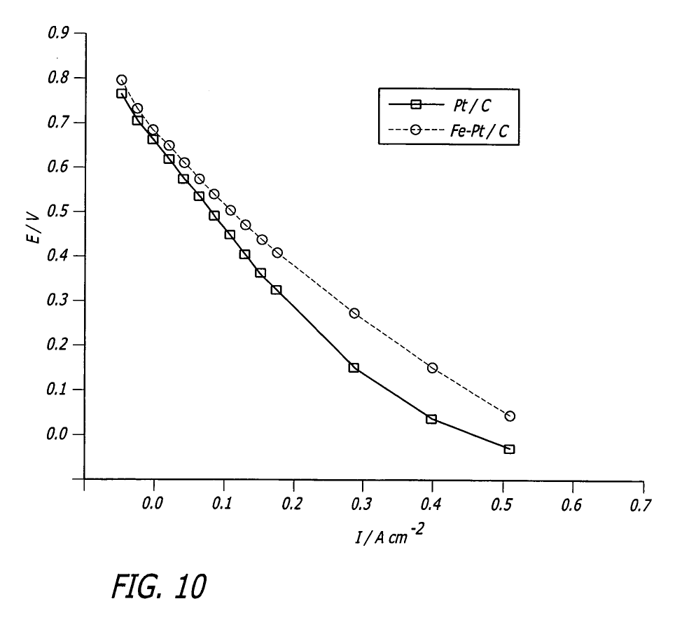

The foregoing describes the results of testing and experiments utilizing an embodiment of the catalyst of the present invention while employing the well-known rotating disk electrode system. Additional experiments were conducted testing the embodiments of the catalyst of the present invention using a membrane electrode assembly (MEA) compatible with conventional fuel cells (see FIG. 11). As shown in FIG. 10, in-situ cell polarization behavior of the membrane electrode assemblies was determined with (Fe—Pt)/C and Pt/C catalysts. It was observed that (Fe—Pt)/C outperforms Pt/C over the entire potential range investigated, as a result of better methanol tolerance of the Fe—Pt/C catalyst of the present invention. At a lower potential range, the performance improvement was observed to be more significant. The enhanced current density can be as high as one-hundred milliamps per square centimeter.

Thus, the present invention provides an efficient methanol-tolerant oxidation reduction reaction catalyst containing platinum and an iron porphyrin, see S. Gupta, D. Tryk, S. K. Zecevic, W. Aldred, D. Guo, R. F. Savinell, Journal of Applied Electrochemistry 28, pp. 673-682 (1998), hereby incorporated herein by reference. The cathodic catalyst combines the benefits of high methanol tolerance provided by the iron porphyrin with high oxidation reduction reaction activity provided by the platinum. Different conditions for the catalyst preparation were investigated, and it was found that the order in which the two metals were deposited on the supporting carbon structure and the sintering temperature are important for producing a successful methanol-tolerant catalyst. The kinetics studies demonstrated that the oxygen reduction on the new catalyst of the present invention still follows the first-order reaction and same mechanism as that on a platinum catalyst, but that the oxygen reduction achieved using the catalyst of the present invention was far more efficient.

Referring to FIG. 11, a direct methanol fuel cell 500 of the present invention includes an anode 510, a cathode 520 and a polymer electrolyte membrane (PEM) 540 positioned between the anode and cathode. A methanol (CH₃OH) in water (H₂O) solution is introduced at the anode, which releases carbon dioxide (CO₂) during methanol oxidation catalyzed by platinum (or other material) contained in the anode. Air or oxygen (O₂) is introduced at the cathode, and water is formed during oxygen reduction (catalyzed by platinum or other material) as protons (H⁺) move across the membrane. A load 550 connected across the anode and cathode completes the electric circuit formed by electrons (e⁻) released during methanol oxidation.

Incorporating the (Fe—Pt)/C catalyst or (Pt—Fe)/C catalyst of the present invention into the cathode 520 solves a known problem with DMFCs 500 referred to as “methanol poisoning.” The problem is caused by methanol crossover from the anode 510 to the cathode through the PEM 540. The crossover creates depolarization losses at the cathode due to simultaneous oxygen reduction and methanol oxidation by the platinum in the cathodic catalyst. The use of iron in the cathodic catalyst reduces the potential for methanol oxidation at the cathode, since iron is more methanol tolerant than platinum. However, the iron provides some potential for oxygen reduction, albeit less than that for platinum. The present invention further incorporates iron macrocycles in the cathodic catalyst, since such macrocycles have relatively high oxidation reduction reaction activity even in the presence of methanol. The present invention is the first to combine an iron macrocycle with platinum on a carbon substrate to inhibit the effects of methanol poisoning on a cathodic catalyst.

While particular forms of the invention have been illustrated and described, it will also be apparent to those skilled in the art that various modifications can be made without departing from the inventive concept. References to use of the invention with a membrane electrode assembly and fuel cell are by way of example only, and the described embodiments are to be considered in all respects only as illustrative and not restrictive. The present invention may be embodied in other specific forms without departing from its spirit or essential characteristics. Accordingly, it is not intended that the invention be limited except by the appended claims.

We claim:

1. A catalyst, comprising:
an iron macrocycle; and
platinum.

2. The catalyst of claim 1, further including a carbon substrate.

3. The catalyst of claim 2, wherein the iron macrocycle is heat-treated on the carbon substrate upon which platinum nanoparticles are then deposited.

4. The catalyst of claim 3, wherein the iron and platinum are sintered on the carbon substrate.

5. The catalyst of claim 2, wherein the platinum is heat-treated on the carbon substrate upon which iron macrocycles are then deposited.

6. The catalyst of claim 1, wherein the iron macrocycle is FeTPP chloride.

7. A direct methanol fuel cell, comprising:
an anode containing a catalyst formed from platinum and carbon;
a cathode containing a catalyst formed from platinum, carbon and an iron macrocycle; and
a membrane disposed between the anode and cathode.

8. The fuel cell of claim 7, wherein the cathodic catalyst is formed by heat-treating the iron macrocycle on a carbon substrate, and by depositing platinum nanoparticles on the iron/carbon substrate.

9. The fuel cell of claim 8, wherein the cathodic catalyst is further formed by sintering the iron and platinum onto the carbon substrate.

10. The fuel cell of claim 9, wherein the iron macrocycle is FeTPP chloride.

11. A method of preparing a catalyst, comprising:
dissolving an iron macrocycle to form a solution;
adding carbon black to the solution to form a mixture;
filtering the mixture through a membrane containing carbon;
heating the membrane and mixture to form an iron/carbon substrate;
depositing platinum on the substrate; and
sintering the platinum and iron.

12. The method of claim 11, wherein dissolving an iron macrocycle includes adding FeTPP chloride to acetone.

13. The method of claim 12, wherein filtering the mixture includes using a PTFE membrane.

14. The method of claim 13, wherein depositing the platinum includes using an alcohol reduction method.

15. The method of claim 14, wherein sintering the platinum and iron includes heating to at least 700° C.
